(19) United States
(12) Patent Application Publication
(10) Pub. No.: US 2025/0001463 A1
(43) Pub. Date: Jan. 2, 2025

(54) METHOD FOR CLEANING THE SURFACES OF HISTORICAL-ARTISTIC INTEREST

(71) Applicant: ALMA MATER STUDIORUM - Universita' di Bologna, BOLOGNA (IT)

(72) Inventors: Giorgia Sciutto, Ravenna (IT); Chiara Gualandi, Molinella (BO) (IT); Francesca Ramacciotti, Bologna (IT); Maria Letizia Focarete, Bologna (IT); Silvia Prati, Bologna (IT); Rocco Mazzeo, Bologna (IT)

(73) Assignee: ALMA MATER STUDIORUM - Universita' di Bologna, BOLOGNA (IT)

(21) Appl. No.: 18/292,791

(22) PCT Filed: Jul. 28, 2022
(86) PCT No.: PCT/EP2022/071159

§ 371 Date: Jan. 26, 2024

(30) Foreign Application Priority Data
Jul. 30, 2021 (IT) 102021000020426

(51) Int. Cl. B08B 1/14; B08B 3/08; B44D 7/00; C11D 7/50; C11D 17/04; D04H 1/4334; D04H 1/4382; D04H 1/56; D04H 1/728; D06M 13/232; D06M 101/34

(52) U.S. Cl. CPC B08B 1/143; B08B 3/08; B44D 7/00; C11D 7/5022; C11D 17/049; D04H 1/4334; D04H 1/43838; D04H 1/56; D04H 1/728; D06M 13/232; D06M 2101/34; D10B 2509/026

(57) ABSTRACT

It is described a method for cleaning surfaces of an item of historical-artistic interest comprising a step of applying a wipe (1), comprising a membrane of non-woven fabric (2) soaked with a solvent, to a surface layer to be removed of said item of historical-artistic interest; it is also described a wipe (1) for cleaning surfaces of an item of historical-artistic interest, in particular a painting work, adapted to carry out said method, and a kit (10) comprising a plurality of wipes (1).

### FIELD OF APPLICATION

In the most general aspect thereof, the present invention refers to the field of cultural heritage preservation and restoration techniques, specifically surfaces of an item of historical-artistic interest, particularly a painting work or an archaeological find, sculptures, archival material or celluloid films.

The invention specifically refers, but not exclusively, to a method for cleaning surfaces of an item of historical-artistic interest, particularly a painting work, by applying a membrane of absorbing material on the surface to be cleaned, in particular on a surface layer to be removed.

The invention also relates to a wipe for cleaning surfaces of an item of historical-artistic interest comprising said membrane of absorbing material.

### PRIOR ART

In the cultural heritage preservation and restoration field, different techniques for cleaning delicate surfaces with a high artistic-cultural value, in general of artworks, through the aid of various tools adapted to the purpose are well known.

The most commonly used tools in cleaning artworks are cotton swabs, wherein the cotton is soaked with a solvent which is able to solubilize and swell the outermost layer, for example paint or varnish, which is intended to be removed.

Usually, the operator initially uses the cotton swabs to apply the solvent to the surface to be cleaned and subsequently uses the same tools to mechanically remove the varnish which was previously dissolved or softened thanks to the interaction with the solvent.

Such operations require a great attention by the operator, who must arbitrarily dose the quantity of solvent.

Furthermore, the just described technique does not always allows to obtain a complete removal of the surface layer, in particular of the varnish surface layer which is intended to be removed, making it necessary to repeat the operations of application of the solvent and the subsequent removal of the residual varnish layer, thus applying different mechanical stresses on the surface of the artwork and using high quantities of solvent.

The mechanical action and the need to repeat the procedures several times can make the removal of the external layer non-selective, the thickness of which may be of a few microns, with the risk to also damage the underlying layers.

Furthermore, the operator can be exposed to the vapours of the solvents, which are often toxic, for prolonged times.

For cleaning the artworks, gels can also be used, which allow a more controlled and superficial application of the solvent.

This technique provides the application of a gel layer soaked with solvent, which is left to rest on the surface to be cleaned for a few minutes; subsequently, the gel layer is removed and, along with this, also the underlying layer to be removed.

However, even this technique does not effectively allow to completely remove the surface layer to be removed in a single application and could require repeated actions, by the aid of cotton swabs or gels, to remove residues of the surface layer to be removed, for example varnish, and/or portions of the gel layer itself, which remain adhered to the surface to be cleaned.

The use of cotton swabs after a cleaning step by gel is disclosed in the publication by Prati, S., Volpi, F., Fontana, R., Galletti, P., Giorgini, L., Mazzeo, R., Tagliavini et al. with the title “Sustainability in art conservation: a novel bio-based organogel for the cleaning of water sensitive works of art”, published on the periodical Pure and Applied Chemistry, 90 (2), 239-251, E. (2018).

The publication by Jia Yiming et al. with the title “Organogel Coupled with Microstructured Electrospun Polymeric Nonwovens for the Effective Cleaning of Sensitive Surfaces”, published on the periodical Appl. Mater. Interfaces, 12, 39620-39629 (2020), discloses the application of sandwich-like composites constituted by an organogel layer sandwiched between two layers of electrospun nonwoven fabric.

Such sandwich is made by firstly applying a solution of poly (3-hydrobutyrate (PHB) and gamma-valerolactone (GLV) to a first layer of electro-spun non-woven at 110° C., then applying a second layer of electro-spun non-woven onto the PHB and GLV layer, while the latter is still warm, and finally letting cool to room temperature the warm composite, thereby obtaining the aforementioned sandwich-like composite.

However, retention capability and gel cohesions may cause uncontrolled release of the solved, undesired painting damages and residues on the object.

Therefore, the need to have a technique for cleaning delicate surfaces of items of high artistic-cultural value, in general artworks, is very much felt by the operators of the field, which allows to overcome the aforementioned limits in relation to cleaning techniques using cotton swabs, gels, similar tools or combinations thereof.

Therefore, the technical problem underlying the present invention is to provide a technique for cleaning delicate surfaces of items of historical-artistic interest which guarantees a selective, precise and complete removal of the surface layer to be removed, reducing the duration and number of operations necessary for this purpose, as well as avoiding the use of huge quantities of solvents, which are often toxic to the operator.

### SUMMARY OF THE INVENTION

Said problem is solved by a method for cleaning surfaces of an item of historical-artistic interest comprising the following steps:
a) providing a wipe comprising a membrane of non-woven fabric, said membrane of non-woven fabric consisting of fibres of polymeric material having an average diameter comprised between 10 nm and 10 μm and being soaked with a solvent;
b) applying said wipe to a surface layer to be removed of said item of historical-artistic interest such that the membrane of non-woven fabric, which is in this way soaked with solvent, is in direct contact with said surface layer to be removed;
c) leaving the wipe in direct contact with said surface layer to be removed for a preset time, wherein the surface layer to be removed swells and adheres to the membrane of non-woven fabric;
d) removing the wipe from said item of historic-artistic interest, wherein said surface layer to be removed, which in this way swelled and adhered to the membrane of non-woven fabric, is removed from said item of historic-artistic interest.

According to the present invention, the expression “item of historical-artistic interest” means an artifact or artwork, whose surface is covered by a surface layer to be removed, that is the outermost and most exposed layer of the artifact or artwork, including a deteriorated varnish surface layer, a damaged protective surface layer, a repainting layer or a deposit layer, the latter normally comprising residues, dusts and dirt deposited over time, which must be periodically removed for preservation purposes.

Preferably, during said step a) said wipe is constituted of membrane of non-woven fabric, more preferably a one-layered membrane of non-woven-fabric, said membrane of non-woven fabric consisting of fibres of polymeric material having an average diameter comprised between 10 nm and 10 μm, and a solvent, wherein said membrane of non-woven fabric is soaked with said solvent.

Preferably, said item of historical-artistic interest may be a painting work, an archaeological find, a sculpture, an item of archival material and/or a celluloid film.

In particular, said item of historical-artistic interest may be an artwork made by applying a painting layer on different types of supports such as wood, canvas, metal, glass, ceramic, terracotta, plaster, paper, papyrus or parchment.

Preferably, said item of historical-artistic interest may be a painting work.

More preferably, said painting work may be a canvas or panel or wood painting or a stony artwork or a decorated architectural element.

In an equally preferred way, when said item of historical-artistic interest is a painting work, said surface layer to be removed may be a varnish surface layer or a repainting.

In particular, when said item of historical-artistic interest is a painting work, said surface layer to be removed may contain one or more among the following materials: resin of natural origin, synthetic resin, beeswax, microcrystalline wax, a protein substance, a pigment or dye mixed with a lipid, protein, polysaccharide binder or with a synthetic resin.

Alternatively, the item of historical-artistic interest may be made of metal, particularly of bronze.

According to the present invention, said solvent is a solvent compatible with said item of historical-artistic interest and it is meant a solvent which is able to be absorbed by the surface layer to be removed of said item of historical-artistic interest without the surface layer being completely dissolved and, in particular, without the solvent penetrating deeply in the layers underlying the surface layer to be removed, thus damaging them.

Preferably, said membrane of non-woven fabric may be soaked with the above-mentioned solvent according to a quantity of solvent comprised between 5 μl and 10 μl per milligram of membrane of non-woven fabric.

Advantageously, depending on the thickness of said membrane of non-woven fabric, depending on the diameter of the fibres of polymeric material of the non-woven fabric which constitutes it, as well as on the material of said surface layer to be removed, the membrane of non-woven fabric is soaked by a preset quantity of solvent.

Therefore, advantageously, the present invention solves the above-mentioned technical problem and in particular the use of huge quantities of solvents, which are often toxic to the operator, is prevented, thus obtaining an advantage both from the point of view of health for the operator and from the environmental point of view, avoiding waste of raw materials, which are often very polluting.

Preferably, the above-mentioned solvent is an organic solvent; more preferably said solvent may be selected from the group consisting of alkyl carbonates, lactones, lactates and any mixture thereof.

Even more preferably, said solvent may be an alkyl carbonate; in a completely preferred way, said solvent may be selected from dimethylcarbonate, diethylcarbonate or any other mixture thereof.

Alternatively, said solvent may be a lactone, preferably gamma-valerolactone.

Alternatively, said solvent may be a lactate, preferably an alkyl lactate, more preferably ethyl lactate.

According to the present invention, the expression “preset time” means a time interval sufficient to allow the surface layer to be removed to at least partially absorb the above-mentioned solvent, wherein said surface layer thus swells and adheres to the membrane of non-woven fabric.

According to a particular applicative mode of the present method, during step c) the surface layer to be removed can interact with said solvent; in particular, in said preset time interval, the surface layer to be removed can be swelled by the solvent.

Preferably, during step c), the wipe is left in direct contact with said surface layer to be removed of said item of historical-artistic interest, for example a painting work, for a time comprised between 30 seconds and 1 hour, more preferably between 1 minute and 15 minutes, even more preferably between 2 minutes and 10 minutes.

In an completely preferred way, during step c), the wipe is left in direct contact with said surface layer to be removed of said item of historical-artistic interest, for example a painting work, for a time equal to 5 minutes.

Therefore, the method according to the present invention provides for the use of a membrane of non-woven fabric consisting of fibres with an average diameter of micrometric or sub-micrometric dimensions as a vehicle for the application of a solvent on a surface layer to be removed of an item of historical-artistic interest, for example a surface painting layer of a painting work.

Advantageously, being provided a wipe comprising a membrane of non-woven fabric soaked with solvent, the operator simply spreads the wipe according to the present invention on the item of historical-artistic interest, for example on a painting work.

The membrane of non-woven fabric is, in this context, placed on the surface layer to be removed, for example a varnish surface layer, to which it adheres.

The operator therefore waits for a very short time, usually a few minutes, without the need to be in close proximity to the application site of the wipe according to the present invention.

The wipe comprising a membrane of non-woven fabric acts autonomously, releasing from the latter the solvent, which penetrates the surface layer to be removed of the item of historical-artistic interest, making it soft and less adherent to the underlying layer.

The absorption of the solvent causes a swelling of the surface layer to be removed which, at least partially, penetrates into the pores present in the membrane of non-woven fabric, adhering to it thanks to the high surface area of the polymeric material fibres which constitute it and having, consistently, an average diameter of micrometric or sub-micrometric dimensions.

Once these steps have been carried out, the operator can finally remove the wipe comprising the membrane of non-woven fabric from the surface of the item of historical-artistic interest, for example a painting work, said item of historical-artistic interest remaining without the surface layer without residues thereof remaining on the underlying layers.

In other words, the present invention allows to obtain the following advantages:
using a wipe comprising a membrane of non-woven fabric consisting of fibrous polymeric material, in which the fibres have an average diameter with micrometric or sub-micrometric dimensions, the solvent can be used in a controlled manner, allowing to carry out an unexceptionable cleaning operation from the point of view of the effectiveness and also absolutely non-aggressive to any possible layers underlying the surface layer to be removed, which, on the other hand, could be damaged by using excessive quantities of solvents;
since the surface layer to be removed is completely removed, without residues thereof remaining on the underlying layers, there is no need to act further by following additional chemical and/or mechanical operations on the surface of the item of historical-artistic interest to be restored, for example a painting work, thus enormously reducing the risk of damaging it;
the exposure times to potentially toxic solvents are reduced, because, once the wipe of the invention has been applied to the surface of the item of historical-artistic interest, the operator is not bound to stop near the application site during step c) of the present method;
furthermore, it must be said that the present method according to the completely preferred applicative modes thereof provides the use of organic solvents with limited or no toxicity for the human body and/or the environment.

According to a particular embodiment of the present invention, the step a) of providing a wipe comprises the following sub-steps:
a1) providing a wipe comprising a membrane of non-woven fabric, said membrane of non-woven fabric consisting of fibres of polymeric material having an average diameter comprised between 10 nm and 10 μm;
a2) soaking the membrane of non-woven fabric with a solvent.

Preferably, according to the latter embodiment, in the step a2) of soaking, said solvent is added to the membrane of non-woven fabric in a quantity comprised between 5 μl and 10 μl per milligram of membrane of non-woven fabric.

According to an embodiment thereof, generally according to the present method, said membrane of non-woven fabric may be obtained by means of an electrospinning technique.

More preferably, said technique of electrospinning comprises the following steps:
i) providing an ejector device and a collector separated from each other, said ejector device comprising a nozzle, preferably said nozzle comprising a capillary, in which the collector comprises an electrically conductive material, preferably in the form of a conductive plate;
ii) generating a voltage between the ejector device and the collector;
iii) feeding a liquid phase comprising a polymer to the ejector device and expelling the liquid phase from said nozzle;
iv) collecting fibres of said polymer on said collector.

More preferably, said liquid phase is a solution comprising a solvent.

Alternatively, said liquid phase is a polymeric melt of said polymer.

In particular, the nozzle of the above-mentioned ejector device and the collector may be separated by a distance comprised between 10 cm and 30 cm, preferably between 15 cm and 25 cm.

Specifically, the voltage generated in step ii) is generally comprised between 2 kV and 30 kV, preferably between 10 kV and 25 kV.

More specifically, during the above-mentioned step iii), the liquid phase can be expelled from said nozzle with a flow rate comprised between 0.005 ml/h and 10 ml/h.

Preferably, according to a particular embodiment thereof, the wipe thus provided in step a) of the present method may only be made with said membrane of non-woven fabric.

Alternatively, according to a different embodiment thereof, the wipe thus provided in step a) of the present method may comprise the above-mentioned membrane of non-woven fabric and, coupled to the latter, a layer of additional material.

According to a particular embodiment of the method of the present invention, said layer of additional material can make the present wipe more manageable for the operator, allowing for example a better grip, as well as giving more strength to the wipe.

Preferably, generally according to the present method, said membrane of non-woven fabric consists of fibres of polymeric material having an average diameter comprised between 50 nm and 5 μm, more preferably between 100 nm and 1 μm.

Preferably, generally according to the present method, said membrane of non-woven fabric has pores of average dimensions comprised between 150 nm and 20 μm, more preferably between 300 nm and 5 μm.

According to an alternative embodiment thereof, generally according to the present method, said membrane of non-woven fabric may be obtained by a spun-bonded technique.

According to the present invention, the term “spun-bonded”, or also spun-laid or spun-bond, means a non-woven fabric obtained directly from polymers and not from a base of fibres or from pre-existing threads: the thus obtained non-woven fabric particularly consists of a mat of extruded continuous fibres or threads from an array of spinnerets, wherein the intersection points between the threads themselves are softened and welded by means of heated presses.

In an equally preferred way, generally according to the present method, the polymeric material which constitutes said membrane of non-woven fabric is selected from polyamides, preferably polyamide 66, polyesters, polyolefins, polyacrylates, polycarbonates, polyurethanes, fluorinated polymers or naturally-derived and biodegradable polymers.

According to an alternative embodiment of the present method, the polymeric material which constitutes said membrane of non-woven fabric is a naturally-derived and biodegradable polymer, more preferably said polymer is polylactic acid.

When the wipe according to the present invention comprises or consists of a membrane in non-woven fabric made of naturally-derived and biodegradable polymeric material, such as for example polylactic acid, a further advantage is that of making a product with further reduced environmental impact, which is compatible with the growing awareness of the consumers.

Preferably, generally according to the present method, said membrane of non-woven fabric has a thickness higher than 150 μm, more preferably comprised between 150 μm and 5 mm, even more preferably between 250 μm and 1 mm, in a completely preferred way between 330 μm and 640 μm.

Advantageously, as will be seen in relation to the examples, using a wipe comprising a membrane of non-woven fabric and, in particular, a wipe consisting of a membrane of non-woven fabric with a thickness comprised between 330 μm and 640 μm, it has been possible to obtain a complete removal of the surface layer to be removed, for example a varnish layer, no alterations of any possible underlying painting layer and no fibrous residues of the wipe used on the surface of the item of historical-artistic interest to be restored, specifically a painting work.

Preferably, generally according to the present method, said wipe may have a length comprised between 5 cm and 20 cm and a width comprised between 1 cm and 20 cm.

Preferably, generally according to the present method, said membrane of non-woven fabric comprises solvent in a quantity of solvent comprised between 6 μl and 7.5 μl, more preferably equal to 7 μl, per milligram of membrane of non-woven fabric.

The above-mentioned technical problem is also solved by a wipe for cleaning surfaces of an item of historical-artistic interest, for example a painting work, comprising a membrane of non-woven fabric, wherein said membrane of non-woven fabric consists of fibres of polymeric material having an average diameter comprised between 10 nm and 10 μm, said membrane of non-woven fabric being soaked with a solvent.

Preferably, said wipe is constituted of membrane of non-woven fabric, more preferably a one-layered membrane of non-woven-fabric, said membrane of non-woven fabric consisting of fibres of polymeric material having an average diameter comprised between 10 nm and 10 μm, and a solvent, wherein said membrane of non-woven fabric is soaked with said solvent.

Preferably, according to the wipe according to the invention, said membrane of non-woven fabric may be soaked with the above-mentioned solvent according to a quantity of solvent comprised between 5 μl and 10 μl per milligram of membrane of non-woven fabric.

Preferably, the above-mentioned solvent is an organic solvent; more preferably said solvent may be selected from the group consisting of alkyl carbonates, lactones, lactates and any mixture thereof.

Even more preferably, said solvent may be an alkyl carbonate; in a completely preferred way, said solvent can be selected from dimethylcarbonate, diethylcarbonate or any mixture thereof.

Alternatively, said solvent can be a lactone, preferably gamma-valerolactone.

Alternatively, said solvent can be a lactate, preferably an alkyl lactate, more preferably ethyl lactate.

Preferably, said membrane of non-woven fabric consists of fibres of polymeric material having an average diameter comprised between 50 nm and 5 μm, more preferably between 100 nm and 1 μm.

Preferably, said membrane of non-woven fabric has pores of average dimensions comprised between 150 nm and 20 μm, more preferably between 300 nm and 5 μm.

Preferably, said membrane of non-woven fabric has a thickness higher than 150 μm, more preferably comprised between 150 μm and 5 mm, even more preferably between 250 μm and 1 mm, in a completely preferred manner between 330 μm and 640 μm.

Preferably, said wipe may have a length comprised between 5 cm and 20 cm and a width comprised between 1 cm and 20 cm.

Preferably, said membrane of non-woven fabric comprises solvent in a quantity of solvent comprised between 6 μl and 7.5 μl, more preferably equal to 7 μl, per milligram of the membrane of non-woven fabric.

Preferably, according to an embodiment thereof, the wipe according to the present invention may only be made with said membrane of non-woven fabric.

Alternatively, according to a different embodiment thereof, the wipe according to the present invention may comprise the above-mentioned membrane of non-woven fabric and, coupled to the latter, a layer of additional material.

In particular, the wipe according to the present invention is a disposable item.

According to a preferred embodiment thereof, generally according to the wipe of the present invention, said membrane of non-woven fabric may be obtained by an electrospinning technique.

According to an alternative embodiment, generally according to the wipe of the present invention, said membrane of non-woven fabric may be obtained by a spun-bonded technique.

In an equally preferred manner, the polymeric material which constitutes said membrane of non-woven fabric is selected from polyamides, preferably polyamide 66, polyesters, polyolefins, polyacrylates, polycarbonates, polyurethanes, fluorinated polymers or naturally-derived and biodegradable polymers, preferably polylactic acid.

According to an alternative embodiment of the wipe according to the present invention, the polymeric material which constitutes said membrane of non-woven fabric is preferably a naturally-derived and biodegradable polymer, more preferably said polymer is polylactic acid.

The above-mentioned technical problem is also solved by a kit comprising a plurality of wipes for cleaning an item of historical-artistic interest according to the present invention and a box adapted to preserve and store said plurality of wipes, wherein the above-mentioned wipes are contained in an internal cavity of said box.

In particular, inside the internal cavity of said box, the above-mentioned wipes can be arranged in a extended manner and side by side.

This last configuration allows a correct optimization of the space available inside the above-mentioned internal cavity, as well as a practical availability for the operator of each individual wipe contained therein.

Preferably, according to a particular embodiment of the present kit, each wipe can be enclosed in a casing capable of preserving adequate conditions of isolation from the external environment, so as to prevent the possible and undesired evaporation of the solvent from said membrane of non-woven fabric, which is in this way soaked.

Preferably, said casing is a sealed bag made of plastic material.

According to an alternative embodiment of the present kit, said box of the above-mentioned kit may preferably be able to preserve adequate conditions of isolation from the external environment in the above-mentioned internal cavity, so as to prevent the possible and undesired evaporation of the solvent from said membrane of non-woven fabric which is in this way soaked.

More preferably, the above-mentioned box of the kit according to the present invention may comprise an opening such as to put said internal cavity of the box in communication with the external environment and reclosing means for the above-mentioned opening.

More preferably, said reclosing means being a hinge.

Advantageously, said closing means allow the operator, once the content of the box, that is said plurality of wipes, has been exposed to the outside air, to reclose the box and thus provide a barrier for said opening such that the evaporation of the solvent soaked in the membranes of non-woven fabric of said wipes is minimized during the preservation time of the wipes.

In an equally preferred manner, said reclosing means are adapted to allow the reclosing of said opening in an airtight manner, preferably said reclosing means being an airtight hinge.

Advantageously, said closing means, which are adapted to allow the reclosing of said opening in an airtight manner, allow the operator, once the content of the box, that is said pluralities of wipes, has been exposed to the outside air, to reclose the box and thus provide a barrier for said opening such that the evaporation of the solvent soaked in the membranes of non-woven fabric of said wipes is avoided during the preservation time of the wipes.

The characteristics and advantages of the present invention will become more evident from the detailed description below, comprising some experimental examples.

Furthermore, further characteristics and advantages of the present invention will become apparent from the detailed description given below in a preferred embodiment example thereof, with reference to the above-mentioned kit, given by way of an indicative and non-limiting example with reference to the attached drawings.

### BRIEF DESCRIPTION OF THE DRAWINGS

FIG. 1 represents a sectional schematic view of a wipe according to an embodiment of the present invention.

FIG. 2 represents a prospective schematic view of a kit comprising a box for a plurality of wipes according to an embodiment of the present invention.

FIG. 3 represents a sectional schematic view of the simulation surface.

FIG. 4 represents the result of the cleaning test in the example 1 reported below, related to the simulation surface A.

FIG. 5 shows the spectra with identification of the main absorbent bands obtained with uFTIR in ATR mode of the simulation surface A, from bottom to top: the simulation surface A before the deposition of the Dammar layer (varnish layer 3 in FIG. 3); pre-cleaning simulation surface A; post-cleaning simulation surface A.

### DETAILED DESCRIPTION

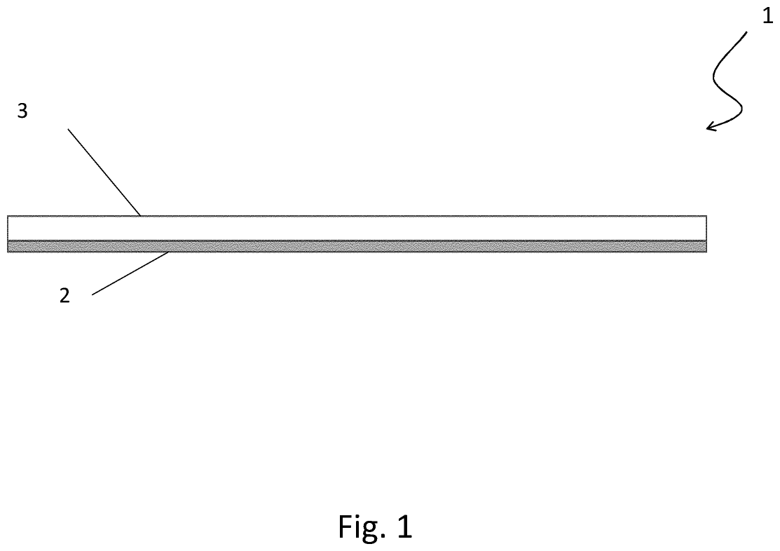

With reference to FIG. 1, 1 globally indicates a wipe for cleaning the surfaces of an item of historical-artistic interest, for example a painting work, comprising a membrane of non-woven fabric 2, said membrane of non-woven fabric being soaked with a solvent, and a layer 3 of additional material, which is different from the polymeric material with which said membrane of non-woven fabric is made.

The layer 3 of additional material is coupled to the membrane of non-woven fabric 2 and is able to make to the wipe 1 more manageable for the operator, allowing a better grip, as well as greater robustness.

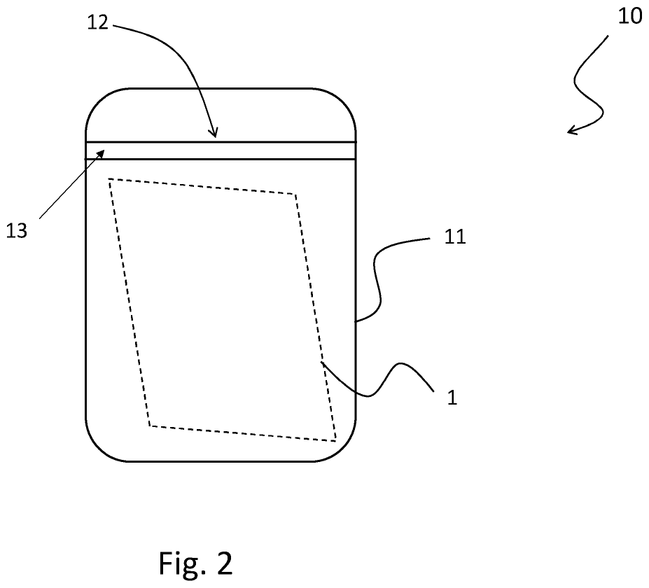

The present invention also refers to a kit comprising a plurality of wipes 1 according to the present invention, schematically illustrated in FIG. 2 and overall indicated with 10.

In particular, the kit 10 comprises a box 11 adapted to preserve and store a plurality of wipes 1 at an internal cavity of the box 11.

For example, with reference to the box 11 illustrated in FIG. 2, the box under consideration may be a flexible box of the bag type.

It is underlined that the shape of the box 11 illustrated in FIG. 2 is completely arbitrary, wherein any more or less complex geometric shape adapted to define a cavity adapted to contain a plurality of wipes is usable.

More in particular, although not shown, the wipes 1 are arranged inside the internal cavity of the box 11 in a extended manner and side by side.

In particular, the box 11 is able to preserve adequate isolation conditions from the external environment in the above-mentioned internal cavity, so as to prevent the possible and undesired evaporation of the solvent from said thus soaked membrane of non-woven fabric.

Conveniently, the box 11 comprises an opening 12 so as to put the internal cavity of the box 11 in communication with the external environment.

In particular, said opening 12 is arranged to extract the wipes 1 from the internal cavity of the box 11 and, in correspondence with it, an airtight hinge 13 is suitably provided.

The airtight hinge 13 allows the operator, once the content of the box, that is the plurality of wipes 1, has been exposed to the outside air, to reclose the box 11, even dozens of times, and thus provide a barrier for the opening 10 such that the evaporation of the solvent soaked in the membrane of the wipes 11 is avoided during the preservation time of the wipes 11.

Some experimental examples are now shown from which the characteristics and advantages of the present invention will be more evident.

### Preparation of a Wipe Made of Non-Woven Fabric Useful for an Application According to the Present Invention

A suitable quantity of polyamide 66 was solubilized in hexafluoroisopropanol at a concentration of 20% w/v.

The solution was electro-spun by applying the following process parameters: needle-collector distance equal to 22 cm; voltage equal to 19 kV (at 3 mL-3.5 KV on the collector); flow rate equal to 0.015 mL/min; quantity of solution used to obtain the yarn equal to 4.6 mL.

A wipe was thus obtained, which consists of a membrane of non-woven fabric with dimensions equal to 10 cm by 10 cm with a thickness comprised between 350 μm and 500 μm.

The wipe was subsequently cut into two substantially quadrangular portions having a dimension equal to 0.7 cm by 0.7 cm, the first with a thickness of 405 microns and the second with a thickness of 436 microns.

### Preparation of Simulation Surfaces of Painting Works:

The following simulation surfaces have been prepared which are able to accurately reproduce real conditions which can be found on the surface of a painting work.

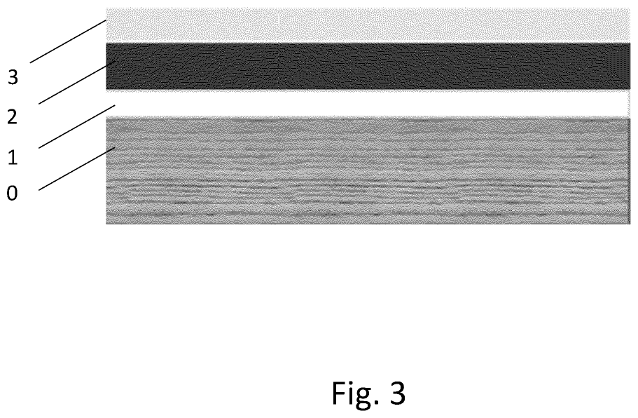

Simulation surface A: wooden support, preparatory layer made with plaster and glue, painting layer made with red ocher and glue, varnish surface layer to be removed made with natural triterpene varnish (Dammar) (see FIG. 3).

In particular, with reference to FIG. 3, the reference number 0 corresponds to the wooden support, 1 indicates the preparatory layer of plaster and glue, 2 the painting layer made with red ocher and glue and 3 the varnish layer (in the case of the simulation surface A it is Dammar, in the case of the simulation surface B it is Paraloid).

Simulation surface B: wooden support, preparatory layer made with plaster and glue, painting layer made with red ocher and glue, varnish surface layer to be removed made with synthetic acrylic varnish (Paraloid).

The thicknesses of the varnishes were evaluated by measuring them by means of an optical microscope in stratigraphic section and corresponded on average to 50 microns for the simulation surface A and on average to 40 microns for the simulation surface B.

### Example 1, Carrying Out the Method According to the Invention for Cleaning the Simulation Surface A

The first substantially quadrangular wipe portion previously obtained with thickness equal to 443 microns was soaked with 19 μL of DMC (dimethylcarbonate) in order to obtain a wipe portion consisting of a membrane of non-woven fabric soaked with DMC according to a quantity of solvent equal to 7 μL per milligram of membrane of non-woven fabric.

Once suitably soaked with the solvent, the wipe portion was transferred onto the simulation surface A to be treated, making the first adhere to the second correctly.

5 minutes after the application, the wipe portion was removed.

### Example 2, Carrying Out the Method According to the Invention for Cleaning the Simulation Surface B

The second substantially quadrangular wipe portion previously obtained with thickness equal to 436 microns was soaked with 24 μL of DMC (dimethylcarbonate) in order to obtain a wipe portion consisting of a membrane of non-woven fabric soaked with DMC according to a quantity of solvent equal to 7 μL per milligram of membrane of non-woven fabric.

Once suitably soaked with the solvent, the wipe portion was transferred onto the simulation surface B to be treated, making the first adhere to the second correctly.

5 minutes after the application, the wipe portion was removed.

### Evaluation of the Cleaning Effectiveness:

The identification of varnish and/or fibre residues was carried out by observing at the stereomicroscope under visible light and UV for and by surface spectroscopic analysis with uFTIR in ATR mode.

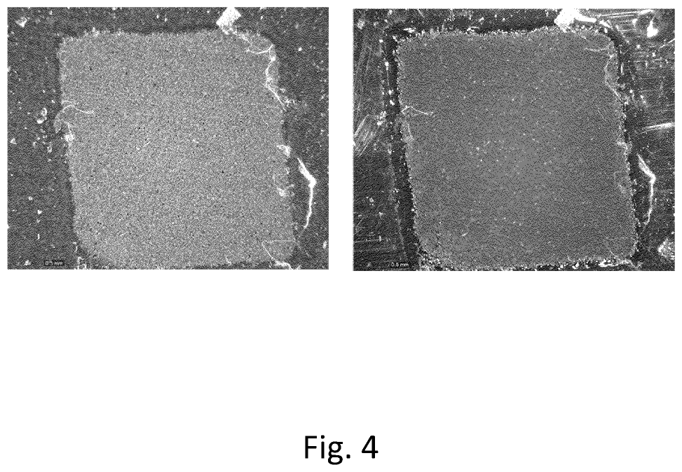

FIG. 4 shows two images obtained with the DinoLite portable microscope in visible light (left) and ultraviolet light (right) of the post-cleaning simulation surface A, that is after the removal of the varnish layer 3 (Dammar), exemplified in FIG. 3, in the area which was previously in contact with square-shaped wipe.

The spectroscopic analysis was instead carried out with the use of a FTIR microscope distributed by the company THERMO Scientific iN10Max, and operating in the mid-infrared region (670-4000 cm⁻¹). The ATR mode (attenuated total reflectance) provides the use of a germanium crystal placed in direct contact with the surface to be inspected. Said molecular analysis allows the recognition of the surface varnishes and possible residues thereof distinguishing them from those of the painting layer.

For a detailed evaluation of possible varnish residues, samples in pre- and post-cleaning areas were collected from the painting surface and embedded in Potassium Bromide (KBr) to allow the observation of the stratigraphy by optical microscopy.

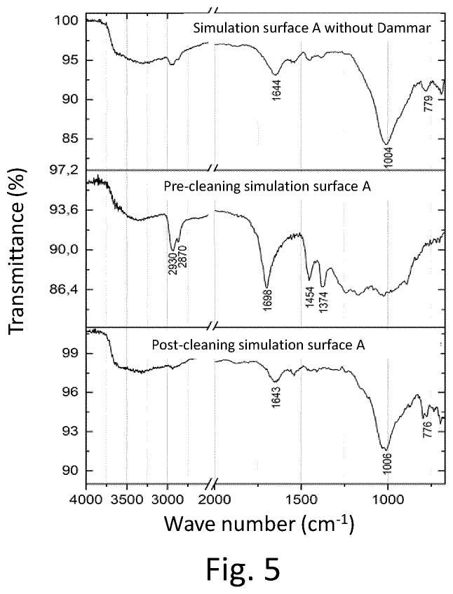

The pre- and post-cleaning areas were furthermore analysed with the infrared microscope uFTIR in ATR mode (FIG. 5).

Thanks to the pre- and post-cleaning monitoring, it was possible to observe that a complete removal of the varnish surface layer to be removed (varnish layer 3, in FIG. 3), no alternation of the underlying painting layer (painting layer of red ocher and glue 2, in FIG. 3) and no fibrous residue of the wipe used on the thus clean surface are obtained with wipes consisting a membrane of non-woven fabric with thicknesses higher than 340 μm. The same observations were made possible for both the simulation surfaces A and B, with reference respectively to the Examples 1 and 2.

1. A method for cleaning the surface of an item of historical-artistic interest, wherein said method comprises:
a) providing a wipe comprising a membrane of non-woven fabric, said membrane of non-woven fabric consisting of fibres of polymeric material having an average diameter comprised between 10 nm and 10 μm and being soaked with a solvent;
b) applying the wipe to a surface layer to be removed of said item of historical-artistic interest such that the membrane of non-woven fabric, which is in this way soaked with solvent, is in direct contact with said surface layer to be removed;
c) leaving the wipe in direct contact with said surface layer to be removed for a preset time, wherein said surface layer to be removed swells and adheres to the membrane of non-woven fabric; and
d) removing the wipe from said item of historic-artistic interest, wherein said surface layer to be removed, which in this way swelled and adhered to the membrane of non-woven fabric, is removed from said item of historic-artistic interest.

2. The method according to claim 1, wherein said item of historical-artistic interest is a painting work, an archaeological find, a sculpture, an item of archival material or a celluloid film.

3. The method according to claim 1, wherein said membrane of non-woven fabric is soaked with said solvent according to a quantity of solvent comprised between 5 μl and 10 μl per milligram of membrane of non-woven fabric.

4. The method according to claim 1, wherein said solvent is an organic solvent.

5. The method according to claim 4, wherein said solvent is selected from the group consisting of alkyl carbonates, lactones, lactates and mixtures thereof.

6. The method according to claim 5, wherein said solvent is an alkyl carbonate.

7. The method according to claim 1, wherein said polymeric material which constitutes said membrane of non-woven fabric is selected from polyamides, polyesters, polyolefins, polyacrylates, polycarbonates, polyurethanes, fluorinated polymers or naturally-derived and biodegradable polymers.

8. The method according to claim 1, wherein said membrane of non-woven fabric is obtained by an electrospinning or a spun-bond technique.

9. The method according to claim 1, wherein said membrane of non-woven fabric consists of fibres of polymeric material having an average diameter comprised between 50 nm and 5 μm.

10. The method according to claim 1, wherein said membrane of non-woven fabric has a thickness higher than 150 μm.

11. A wipe for cleaning surfaces of an item of historical-artistic interest comprising a membrane of non-woven fabric, wherein said membrane of non-woven fabric consists of fibres of polymeric material having an average diameter comprised between 10 nm and 10 μm, said membrane of non-woven fabric being soaked with a solvent.

12. The wipe according to claim 11, wherein said membrane of non-woven fabric is soaked with a quantity of solvent comprised between 5 μl and 10 μl per milligram of membrane of non-woven fabric.

13. The wipe according to claim 11, wherein said solvent is an organic solvent, and is selected from the group consisting of alkyl carbonates, lactones, lactates and mixtures thereof

14. The wipe according to claim 13, wherein said solvent is an alkyl carbonate.

15. A kit comprising a plurality of wipes for cleaning surfaces of an item of historical-artistic interest according to claim 11 and a box adapted to preserve and store said plurality of wipes, wherein said wipes are contained in an internal cavity of said box and wherein said box comprises an opening such as to put the internal cavity of the box in communication with the external environment and reclosing means for said opening.

16. The method according to claim 1, wherein said item of historical-artistic interest is a painting work.

17. The method according to claim 6, wherein said solvent is dimethyl carbonate, diethyl carbonate or any other mixture thereof.

18. The method according to claim 1, wherein said membrane of non-woven fabric has pores of average dimensions comprised between 150 nm and 20 μm.

19. The method according to claim 10, wherein said membrane of non-woven fabric has a thickness comprised between 150 μm and 5 mm.

20. The wipe according to claim 14, wherein said solvent is dimethyl carbonate, diethyl carbonate or any other mixture thereof.
